(19) United States
(12) Patent Application Publication
(10) Pub. No.: US 2022/0320956 A1
(43) Pub. Date: Oct. 6, 2022

(54) An Electrical Machine Comprising an Integrated Magnetic Torsion Spring

(71) Applicant: Universiteit Gent, Gent (BE)

(72) Inventors: Peter Sergeant, Lievegem (BE); Mohamed Nabil Fathy Ibrahim, Gent (BE); Hendrik Vansompel, Moerbeke-Waas (BE)

(73) Assignee: Universiteit Gent, Gent (BE)

(21) Appl. No.: 17/616,269

(22) PCT Filed: Jun. 5, 2020
(86) PCT No.: PCT/EP2020/065674

§ 371 Date: Dec. 3, 2021

(30) Foreign Application Priority Data
Jun. 5, 2019 (EP) 19178354.7

(51) Int. Cl. H02K 7/108; H02K 16/04

(52) U.S. Cl. CPC H02K 7/1085; H02K 16/04

(57) ABSTRACT

An electrical machine (1) comprising: a rotatable drive shaft having a rotational axis (15); a rotor assembly (2) connected to the drive shaft, the rotor assembly 2 arranged to generate a static rotor magnetic field; a primary stator assembly (4), comprising a plurality of stator coils (5a, 5b) arranged to generate a rotating stator magnetic field for interacting with the static rotor magnetic field of the rotor assembly (2) such as to rotate the rotor assembly (2) along the rotational axis (15), and a secondary stator assembly (7) arranged to generate a static stator magnetic field; wherein the electrical machine (1) comprises a magnetic torsion spring (9) formed by the interaction of the static stator magnetic field with the static rotor magnetic field.

### TECHNICAL FIELD

The invention relates to an electrical machine such as an electrical generator or an electrical motor. The invention in particular relates to an apparatus comprising an electrical machine, wherein the apparatus is configured to generate a pulsed output torque with high peak-to-peak amplitude suitable for applications that are subject to reciprocating movement. Such an apparatus is further referred to as a pulsating torque apparatus.

### STATE OF THE ART

Many industrial devices are driven by electromotors that provide the required torque to the device. In many industrial applications, referred to as pulsating torque applications, the torque profile required by the devices includes a high peak-to-peak amplitude. In these applications, a device is often moved in repetitive cycles, wherein the amount of torque that is required by the device fluctuates strongly throughout the cycle. In particular, devices that perform reciprocating movements are known to have torque profiles with high peak-to-peak amplitude. Weaving looms for example require high peak torque but low average torque. Another device that requires a high peak torque but low average torque is a baler to compress straw. During the compression of the straw an increased torque and power is required of the driving motor, whilst the removal of the compressor requires a low amount of torque and power.

Conventionally, an electromotor that is sufficiently powerful, and thus large, is required in order to deliver the required peak torque and power in the above mentioned applications. Such a motor is expensive, heavy and requires the provision of a large volume to host the motor. In the above mentioned applications, the average torque and power that is required is however very low in comparison to the required peak torque and power. The global efficiency is thus usually low.

In the state of the art, such as in patent publication U.S. Pat. No. 7,265,470, an apparatus has therefore been provided that can deliver a strongly pulsating torque, with a low average power consumption i.e. a pulsating torque apparatus. The apparatus of the state of the art provides a housing encompassing an electrical machine, i.e. an electromotor comprising a rotor and a stator, a shaft driven by the electrical machine, and a magnetic torsion spring provided on the shaft. The magnetic torsion spring in the state of the art is formed by providing a set of permanent magnets distally from the electrical machine on the same shaft that is driven by the electrical machine and by surrounding the set of permanent magnets with a second stator. It has however been found that the solutions of the state of the art are costly, and require a large volume to host the apparatus.

### DESCRIPTION OF THE INVENTION

It is an object of the present invention to provide a pulsating torque apparatus, wherein the problems of the state of the art are solved. In particular it is an object of the present invention to provide a pulsating torque apparatus that is more compact. It is a further object of the present invention to provide a pulsating torque apparatus that is less costly to manufacture.

The present invention therefore provides an apparatus which can be described as an electrical machine such as an electromotor or electrical generator, with integrated magnetic torsion spring. The electrical machine of the present invention can be referred to as a pulsating torque electrical machine. The electrical machine of the present invention can preferably be summarized as a pulsating torque apparatus wherein a rotor assembly is positioned adjacent to a primary stator assembly such as to form a conventional electrical machine i.e. a conventional electromotor or a conventional electrical generator, and wherein the same rotor assembly is also positioned adjacent to a secondary stator assembly such as to form a magnetic torsion spring. The rotor assembly is thereby preferably the only rotor assembly in the electrical machine. In a first aspect of the invention, as described in a first part of the present description, the invention is limited to machines wherein the conventional electrical machine part is a synchronous electrical machine, preferably a permanent magnet (PM) synchronous electrical machine. In a second aspect of the invention, as described in a second part of the present description, the invention is not limited to a machine wherein the conventional electrical machine part is a (PM) synchronous machines, i.e. by also incorporating induction machines and reluctance machines.

Below, the first aspect of the present invention will be explained. The first aspect of the present invention relates to a machine wherein the conventional electrical machine part is a synchronous electrical machine, preferably a permanent magnet synchronous electrical machine.

The present invention provides an electrical machine according to the first claim. The electrical machine comprises a rotatable drive shaft having a rotational axis, for example extending in an axial direction, and a rotor assembly connected to the drive shaft. The rotor assembly is arranged to generate, for example in use, a static rotor magnetic field. The rotor assembly preferably comprises a set of magnetic pole forming means such as preferably a set of permanent magnets (PM), arranged annularly around the rotational axis and for example connected to the drive shaft. Preferably the set of magnetic pole forming means of the rotor assembly is arranged to generate, for example in use, the static rotor magnetic field or a part of the static rotor magnetic field. The electrical machine furthermore comprises a primary stator assembly comprising a plurality of stator coils arranged to generate, for example in use, a rotating stator magnetic field for interacting with the static rotor magnetic field of the rotor assembly such as to rotate the rotor assembly along the rotational axis. The electrical machine for example comprises an electromotor formed by the interaction of the static rotor magnetic field with the rotating stator magnetic field. The electrical machine furthermore comprises a secondary stator assembly arranged to generate, for example in use, a static stator magnetic field. The secondary stator assembly preferably comprises a further set of magnetic pole forming means, arranged annularly around the rotational axis, but disconnected from the drive shaft. Preferably, the further set of magnetic pole forming means of the secondary stator assembly is arranged to generate, for example in use, the static stator magnetic field. The electrical machine comprises a magnetic torsion spring formed by the interaction of the static stator magnetic field with the static rotor magnetic field.

Providing an electrical machine wherein the magnetic torsion spring is formed by the interaction of the static rotor magnetic field and the static stator magnetic field, and wherein the rotor assembly is furthermore rotated by the interaction of the static rotor magnetic field and the rotating stator magnetic field, has the advantage that a compact and low-cost pulsating torque apparatus is provided. Indeed, in the state of the art, in particular in the apparatus disclosed in U.S. Pat. No. 7,265,470, two axially separated rotor assemblies are provided on one axially extending drive shaft. This not only requires the time consuming assembly of more costly material i.e. two times the amount of rotor core material supporting the magnetic pole forming means, and two times the connection of the rotor assembly to the drive shaft, but also makes it more costly to provide adequate cooling i.e. because multiple cooling arrangements must be provided for each one of the axially separated rotor assemblies. Furthermore, in the state of the art, in particular in the apparatus disclosed in U.S. Pat. No. 7,265,470, an additional static rotor magnetic field is generated within the magnetic torsion spring part by additional magnetic pole forming means, in particular by an additional set of permanent magnets annularly disposed around, and connected to, the drive shaft at an axially distal position with respect to the rotor assembly of the electrical machine. It has furthermore been found that the present invention enables to create a compact pulsating torque apparatus, because it is no longer necessary to provide an elongated and voluminous apparatus housing that encompasses the electrical machine such as the electromotor and the axially distally positioned magnetic torsion spring.

In an embodiment of the present invention that will be further described below, the static rotor magnetic field is generated by a single set of magnetic pole forming means and the static rotor magnetic field generated by the single set of magnetic pole forming means interacts with both the rotating stator magnetic field and the static stator magnetic field. It has been found that by using the static rotor magnetic field simultaneously for driving the rotor assembly by interaction with the rotating stator magnetic field and for providing the pulsating torque by interaction with the static stator magnetic field, the need for an additional static rotor magnetic field is alleviated, in particular when implementing the embodiment as stated above. Therefore, when implementing the embodiment as stated above, the additional magnetic pole forming means for generating the additional static rotor magnetic field can be omitted from the apparatus. It has been found that these additional magnetic pole forming means are an important cost factor in the production of pulsating torque apparatuses. By providing the electrical machines of the present invention, the costs for manufacturing pulsating torque apparatuses are thus reduced.

As stated above, the apparatus of the present invention can be described as an electrical machine such as an electromotor, with integrated magnetic torsion spring. The electrical machine of the present invention can be referred to as a pulsating torque electrical machine. The electrical machine of the present invention can preferably be summarized as a pulsating torque apparatus wherein a rotor assembly is positioned adjacent to a primary stator assembly such as to form a conventional electrical machine such as a conventional (PM) synchronous electrical machine, i.e. a conventional (PM) synchronous electromotor or a conventional (PM) synchronous electrical generator, and wherein the same rotor assembly is also positioned adjacent to a secondary stator assembly such as to form a magnetic torsion spring. The rotor assembly is thereby preferably the only rotor assembly in the electrical machine.

The static rotor magnetic field is static when seen in the reference frame of the rotor. The static rotor magnetic field is referred to as a static magnetic field for example as it is static with respect to the rotor assembly, for example to the magnetic pole forming means that generate the static rotor magnetic field. The static rotor magnetic field is for example not actively changed within a single rotational cycle of the rotor assembly. It is noted however that, as the rotor assembly rotates with respect to the stator assemblies, the static rotor magnetic field is not static when viewed from one of the stator assemblies.

The rotating stator magnetic field is rotating when seen in the reference frame of the primary stator. The rotating stator magnetic field is referred to as a rotating magnetic field for example as it rotates with respect to the primary stator assembly stator coils that generate the rotating stator magnetic field. The rotating stator magnetic field is for example actively changed during a rotation cycle of the rotor assembly. It is known in the art, for example in the field of synchronous-type or induction-type electromotors, how to generate a rotating magnetic field. By preference, the stator coils carry a three-phase AC current in order to generate the rotating stator magnetic field. In an embodiment, the stator coils carry more than three phases of AC current. Accordingly, the windings of the stator coils are wound in the corresponding three, or more phase arrangement.

The static stator magnetic field is static when seen in the reference frame of the secondary stator. The static stator magnetic field is referred to as a static magnetic field for example as it is static with respect to the secondary stator assembly, for example to the magnetic pole forming means that generate the static stator magnetic field. The static stator magnetic field is for example not actively changed within a single rotational cycle of the rotor assembly. In an embodiment, the strength and/or pattern of the static stator magnetic field can be actively changed, for example initially set, in order to adapt the pulsating torque apparatus to the required industrial application. The strength and/or pattern of the static stator magnetic field are preferably adapted such as to provide the pulsating torque profile that is required by the industrial application. The static stator magnetic field can thus also be referred to as a quasi-static magnetic field. In an embodiment, also the static rotor magnetic field is a quasi-static magnetic field.

According to an embodiment of the present invention, the static rotor magnetic field is generated, i.e. solely generated, by a single set of magnetic pole forming means annularly arranged around the rotational axis, for example a single set of PM annularly arranged around the rotational axis. In the present embodiment, the static rotor magnetic field generated by the single set of magnetic pole forming means interacts with both the rotating stator magnetic field and the static stator magnetic field such as to respectively form the motor/generator and the magnetic torsion spring. In an implementation, the single set of magnetic pole forming means is provided along the surface of the rotor assembly facing the primary stator assembly. The term ‘along the surface of the rotor assembly’ preferably comprises one of being provided on top of the surface of the rotor assembly and being provided in the rotor assembly adjacent to the rotor assembly surface. Preferably however, the single set of magnetic pole forming means is provided substantially centrally of the rotor assembly i.e. substantially centrally between the surface of the rotor assembly facing the primary stator assembly and the surface of the rotor assembly facing the secondary stator assembly, for example provided substantially centrally in the radial direction in case the rotor assembly and the two stator assemblies are radially nested. This preferred arrangement enables the static rotor magnetic field to optimally interact with both the rotating stator magnetic field and the static stator magnetic field.

According to an alternative embodiment of the present invention, the static rotor magnetic field is generated by two sets of magnetic pole forming means annularly arranged around the rotational axis, such as two sets of PM annularly arranged around the rotational axis. The first and second sets of magnetic pole forming means together generate the static rotor magnetic field. Preferably, the first set of magnetic pole forming means of the rotor assembly is provided adjacent to, for example along, the surface of the rotor assembly facing the primary stator assembly, for example the radially outer surface of the rotor assembly when the primary stator assembly is positioned radially outward of the rotor assembly. The term ‘along the surface of the rotor assembly’ preferably comprises one of being provided on top of the surface of the rotor assembly and being provided in the rotor assembly adjacent to the rotor assembly surface. This arrangement enables the part of the static rotor magnetic field generated by the first set of magnetic pole forming means to optimally interact with the rotating stator magnetic field. Preferably, the second set of magnetic pole forming means is provided adjacent to, for example along, the surface of the rotor assembly facing the secondary stator assembly, for example the radially inner surface of the rotor assembly when the secondary stator assembly is positioned radially inward of the rotor assembly. The term ‘along the surface of the rotor assembly’ preferably comprises one of being provided on top of the surface of the rotor assembly and being provided in the rotor assembly adjacent to the rotor assembly surface. This arrangement enables the part of the static rotor magnetic field generated by the second set of magnetic pole forming means to optimally interact with the static stator magnetic field. Preferably, the first and second sets of magnetic pole forming means are separated from each other by a layer having an increased reluctance such as a layer of air or adhesive. The present embodiment has the advantage that the first and the second sets of magnetic pole forming means can be optimized to the interaction with respectively the rotating stator magnetic field and the static stator magnetic field. According to an embodiment of the present invention, the rotor assembly comprises two interconnected annular parts. The annular parts are interconnected such that the entirety of the rotor assembly rotates at the same angular velocity. The annular parts are connected to each other, such that the two parts are adjacent to each other, i.e. not merely interconnected via the axially extending drive shaft. In other words, the interconnected annular parts together form the rotor assembly, preferably the only rotor assembly, of the electrical machine. The interconnection can be made by providing interconnecting means on the opposing surfaces of the opposing annular parts. The annular parts can for example be provided with complementary mechanical interconnection means such as grooves and complementary protrusions, or for example with an adhesive interconnection means. In an embodiment, the interconnection means have a relatively high reluctance with respect to the remainder of the rotor core, for example due to the airgaps left between the imperfect matching of the complementary mechanical interconnection means or due to the relatively low magnetic permeability of the interconnection means itself such as the relatively low magnetic permeability of the adhesive interconnection means. The interconnection of the annular parts can be either releasable/separable or permanent, but preferably, the interconnection is not releasable/separable by the mere rotation of the rotor assembly along the rotational axis at conventional angular velocities for example at 300 rpm for low speed applications up to 6000 rpm for high speed applications.

According to an embodiment of the present invention, the first annular part of the rotor assembly comprises the first set of magnetic pole forming means of the rotor assembly, preferably the first set of PMs, generating a part of the static rotor magnetic field. Therefore, the second annular part of the rotor assembly comprises the second set of magnetic pole forming means, preferably the second set of PMs, also generating a part of the static rotor magnetic field. It has been found that the present embodiment enables to create a modular electrical machine, wherein the electrical motor/generator is formed by the primary stator assembly and the first annular part of the rotor assembly, and wherein the magnetic torsion spring is formed by the secondary stator assembly and the second annular part of the rotor assembly. The modular approach of the pulsating torque electrical machine of the present invention enables to improve the cost effective commercialization of the machine. The present modular approach enables assembling the entire electrical machine of the present invention, for example via the interconnection means, for a targeted application by reusing the rotor part of a reference electrical motor/generator design of one application with similar motor/generator requirements as the targeted application and the rotor part of a reference magnetic torsion spring design of another application with similar spring requirements as the targeted application.

It has been found that the requirements of a pulsating torque electrical machine for a particular industrial application can indeed be categorized based on two dominant parameters.

The first parameter is the required angular velocity of the industrial application. Low speed industrial applications require an electrical machine that runs at a low angular velocity for example up to 3000 rpm, for example between 300 rpm to 2000 rpm. An example low speed industrial application is a weaving loom. For such low speed industrial applications, the motor/generator part of the electrical machine, i.e. the part formed by the primary stator assembly and the first annular part of the rotor assembly, can be optimized to function at the low angular velocity. The rotating stator magnetic field of the primary stator assembly, in particular as observed in the airgap between the rotor assembly and the primary stator assembly, is for example provided with a relatively high number of alternating magnetic poles compared to the rotating stator magnetic field, in particular as observed in the airgap between the rotor assembly and the primary stator assembly, of the primary stator assembly used in high speed industrial applications, in accordance with the established relation between the synchronous speed of an electrical machine on the one hand and the electrical driving frequency and the inverse of the number of magnetic pole pairs on the other hand. The first set of magnetic pole forming means of the first annular part of the rotor assembly is adapted accordingly, for example by generating the same high number of alternating magnetic poles, in particular as observed in the airgap between the rotor assembly and the primary stator assembly. Increasing the number of alternating magnetic poles of the rotating stator magnetic field in order to decrease the angular velocity of the electrical machine, has the advantage that the radial thickness of the yoke of the primary stator assembly can be reduced, because if there are more poles for the same axial length and circumference of the airgap between the primary stator assembly and the rotor assembly, then the size of a pole becomes smaller, causing the magnetic flux per pole to decrease and resulting in a thinner yoke to be sufficient to carry the magnetic flux from one pole to another. This drastically reduces the weight of the electrical machine, in particular when the primary stator assembly is provided radially outward from the rotor assembly. High speed industrial applications require an electrical machine that runs at a high angular velocity for example up to 6000 rpm, for example between 3000 rpm to 6000 rpm. An example high speed industrial application is a drilling compressor machine, or a screw compressor. The screw compressor is a high speed industrial applications which also has vibrations caused by the meshing of the male and female screw. For such high speed industrial applications, the motor/generator part of the electrical machine, i.e. the part formed by the primary stator assembly and the first annular part of the rotor assembly, can be optimized to function at the high angular velocity. The rotating stator magnetic field of the primary stator assembly is for example provided with a relatively low number of alternating magnetic poles, in particular as observed in the airgap between the rotor assembly and the primary stator assembly, compared to the rotating stator magnetic field, in particular as observed in the airgap between the rotor assembly and the secondary stator assembly, of the primary stator assembly used in low speed industrial applications, in accordance with the established relation between the synchronous speed of an electrical machine on the one hand and the electrical driving frequency and the inverse of the number of magnetic pole pairs on the other hand. The first set of magnetic pole forming means of the first annular part of the rotor assembly is adapted accordingly, for example by generating the same low number of alternating magnetic poles, in particular as observed in the airgap between the rotor assembly and the primary stator assembly.

The second parameter is the required periodicity of the pulsating torque profile per revolution of the rotor assembly. Low frequency industrial applications require an electrical machine wherein the magnetic torsion spring has a torque pulsation of one or two periods per revolution of the rotor assembly. An example low frequency industrial application is a weaving loom. A weaving loom is typically driven by the electrical machine via a four-bar linkage such as a crank-rocker linkage, wherein the crank is revolved continuously by the electrical machine and wherein the rocker discontinuously rocks the weaving loom in a reciprocating movement i.e. forth and back between extremal positions of the weaving loom. For each revolution of the crank, the rocker translates one time forth and one time back over a single path between two extremal positions for example between a first position wherein the weaving loom is elevated and a second position wherein the weaving loom is brought down. In order to accelerate the weaving loom out of any extremal position, a positive amount of torque is required from the electrical machine. In order to decelerate the weaving loom upon approaching the other extremal position, a negative amount of torque is required from the electrical machine. In one revolution of the electrical machine, i.e. upon moving the weaving loom from a first extremal position to the second extremal position and back to the first extremal position, the required torque is thus respectively positive, negative, positive and again negative. In one revolution of the electrical machine, two periods of torque pulsation are thus required. For such low frequency industrial applications, the magnetic torsion spring part of the electrical machine, i.e. the part formed by the secondary stator assembly and the second annular part of the rotor assembly, can be optimized to function at the low frequency. As will be explained in further embodiments below, the rotor assembly and the secondary stator assembly are arranged such as to create the required amount of equilibrium positions, wherein the amount of stable equilibrium positions should be chosen equal to the required periodicity, i.e. two stable equilibrium positions should be provided if the industrial application requires at periodicity of two torque periods per revolution of the rotor assembly. The static stator magnetic field of the secondary stator assembly is for example provided with a relatively low number of alternating magnetic poles, in particular as observed in the airgap between the rotor assembly and the secondary stator assembly, compared to the static stator magnetic field, in particular as observed in the airgap between the rotor assembly and the secondary stator assembly, of the secondary stator assembly used in high frequency industrial applications. The static rotor magnetic field, in particular as observed in the airgap between the rotor assembly and the secondary stator assembly, of the single set or where applicable the second set of magnetic pole forming means of the second annular part of the rotor assembly, is adapted accordingly, for example by providing the same low number of alternating magnetic poles, in particular as observed in the airgap between the rotor assembly and the secondary stator assembly. High frequency industrial applications require an electrical machine wherein the magnetic torsion spring has a torque pulsation of more than two periods per revolution of the rotor assembly, for example having up to ten periods per revolution of the rotor assembly. An example of a high frequency industrial application is a vibrating machine. For such high frequency industrial applications, the magnetic torsion spring part of the electrical machine, i.e. the part formed by the secondary stator assembly and the second annular part of the rotor assembly, can be optimized to function at the high frequency. As will be explained in further embodiments below, the rotor assembly and the secondary stator assembly are arranged such as to create the required amount of equilibrium positions, wherein the amount of stable equilibrium positions should be chosen equal to the required periodicity, i.e. ten stable equilibrium positions should be provided if the industrial application requires at periodicity of ten torque periods per revolution of the rotor assembly. The static stator magnetic field of the secondary stator assembly is for example provided with a relatively high number of alternating magnetic poles, in particular as observed in the airgap between the rotor assembly and the secondary stator assembly, compared to the static stator magnetic field, in particular as observed in the airgap between the rotor assembly and the secondary stator assembly, of the secondary stator assembly used in low frequency industrial applications. The static rotor magnetic field, in particular as observed in the airgap between the rotor assembly and the secondary stator assembly, of the second set of magnetic pole forming means of the second annular part of the rotor assembly is adapted accordingly, for example by generating the same high number of alternating magnetic poles, in particular as observed in the airgap between the rotor assembly and the secondary stator assembly. The present invention thus allows to easily assemble a pulsating torque electrical machine that is optimally adapted to the angular speed and torque pulsation frequency required by the industrial application.

Whenever the term “static rotor magnetic field” or “the alternating magnetic poles of the static rotor magnetic field” is used in the context of interaction with the “static stator magnetic field” or its alternating magnetic poles, the term preferably refers to the part of the static rotor magnetic field, or accordingly its alternating magnetic poles, as observed in the airgap between the rotor assembly and the secondary stator assembly, as generated by the single set of magnetic pole forming means of the rotor assembly or where applicable, i.e. when the static rotor magnetic field is generated by two sets of magnetic pole forming means as previously described, as mainly generated by the second set of magnetic pole forming means of the rotor assembly. Whenever in the present application the term “static rotor magnetic field” or “the alternating magnetic poles of the static rotor magnetic field” is used in the context of interaction with the “rotating stator magnetic field” or its alternating magnetic poles, the term preferably refers to the part of the static rotor magnetic field, or accordingly its alternating magnetic poles, as observed in the airgap between the rotor assembly and the primary stator assembly, as generated by the single set of magnetic pole forming means of the rotor or where applicable i.e. when the static rotor magnetic field is generated by two sets of magnetic pole forming means as previously described, as mainly generated by the first set of magnetic pole forming means of the rotor assembly. Whenever the term “magnetic pole forming means of the rotor assembly” is used without further specifying if this refers to the single, first and/or second set of magnetic pole forming means, the term is preferably interpreted as referring to the single set of magnetic pole forming means of the rotor assembly or where applicable, i.e. when two sets of magnetic pole forming means are provided on the rotor assembly as described previously, referring to the second set of magnetic pole forming means.

Whenever the term “rotor assembly circumference” is used in combination with the “secondary stator circumference”, and vice versa, the term ‘circumference’ preferably refers to the circumference defined by the surfaces delimiting the airgap between the rotor assembly and the secondary stator assembly.

According to an embodiment of the present invention, the static stator magnetic field and the static rotor magnetic field are movable relative to one another, in particular due to the rotation of the rotor assembly along the rotational axis. The static rotor and static stator magnetic fields are forming a plurality of stable equilibrium positions and a plurality of unstable equilibrium positions. The plurality of stable and unstable equilibrium positions are located around the rotational axis. The term ‘position’ is preferably interpreted as an angular position of the rotor assembly with respect to the secondary stator assembly. The plurality of stable and unstable equilibrium positions are for example obtained at predetermined angular positions of the rotor assembly with respect to the secondary stator assembly. The plurality of unstable equilibrium positions are located interspersed between the stable equilibrium positions. Upon rotating the rotor assembly, the rotor assembly will for example encounter a stable or unstable equilibrium position and will subsequently encounter respectively an unstable or stable equilibrium position. The rotor assembly is rotatable towards and past any given one of said equilibrium positions in a springing manner via magnetic forces created by said interaction of the static rotor and static stator magnetic fields. The rotation of the rotor assembly towards a stable equilibrium position will be assisted by the interaction of the static rotor and static stator magnetic fields. This interaction of the static rotor and static stator magnetic fields for example comprises the attraction of the rotor assembly in the direction of rotation towards the stable equilibrium position. This interaction creates a positive torque on the rotor assembly, i.e. a torque that accelerates the rotation of rotor assembly along its direction of rotation. The rotation of the rotor assembly away from a stable equilibrium position will be countered by the interaction of the static rotor and static stator magnetic fields. This interaction of the static rotor and static stator magnetic fields for example comprises the attraction of the rotor assembly in the opposite direction of rotation towards the stable equilibrium position. This interaction creates a negative torque on the rotor assembly i.e. a torque that accelerates the rotation of rotor assembly along a direction opposite to its direction of rotation. The rotation of the rotor assembly away from an unstable equilibrium position will be assisted by the interaction of the static rotor and static stator magnetic fields. This interaction of the static rotor and static stator magnetic fields for example comprises the repulsion of the rotor assembly in the direction of rotation away from the unstable equilibrium position. This interaction creates a positive torque on the rotor assembly. The rotation of the rotor assembly towards an unstable equilibrium position will be countered by the interaction of the static rotor and static stator magnetic fields. This interaction of the static rotor and static stator magnetic fields for example comprises the repulsion of the rotor assembly in the opposite direction of rotation away from the unstable equilibrium position. This interaction creates a negative torque on the rotor assembly.

According to an embodiment of the present invention, the equilibrium positions are defined as the positions where the interaction of the static stator and static rotor magnetic fields creates no torque. The magnetic torsion spring is arranged to transduce kinetic energy of the rotor assembly into potential energy and vice versa. According to a preferred embodiment of the present invention, the stable and unstable equilibrium positions are defined as the positions where the potential energy stored in the magnetic torsion spring are respectively at a minimum and at a maximum.

According to an embodiment of the present invention, the static rotor magnetic field comprises a first number of alternating magnetic poles distributed along the rotor assembly circumference, and the static stator magnetic field comprises a second number of alternating magnetic poles distributed along the secondary stator assembly circumference. The ‘alternating magnetic poles’ preferably comprise an alternation of magnetic north and south poles. The rotor assembly is separated from the secondary stator assembly by an airgap, allowing the rotor assembly to rotate with respect to the secondary stator assembly. By preference the alternating magnetic poles of the static rotor and static stator magnetic fields are the magnetic poles as observed within the airgap.

According to an embodiment of the present invention, the static rotor magnetic field and/or the static stator magnetic field, are formed by a sequence of annularly arranged magnetic pole forming means, for example a sequence of PMs or a sequence of coils. In an embodiment, the magnetic pole forming means are oriented substantially radially, for example radially magnetized, for example creating magnetic pole pairs whose magnetic poles are substantially radially disposed. In another embodiment, the magnetic pole forming means are oriented substantially tangentially, for example tangentially magnetized, for example creating magnetic pole pairs whose magnetic poles are substantially tangentially disposed. The alternating magnetic poles are obtained by reversing the orientation of the consecutive magnetic pole forming means, for example by consecutively rotating the tangentially arranged PMs such as to face poles with the same polarity of consecutive PMs towards each other. Preferably, the amount of alternating magnetic poles as observed within the airgap equals the amount of magnetic pole forming means. Preferably, the term “airgap” used in the present embodiment refers to the airgap formed between the rotor assembly and the secondary stator assembly. According to a further embodiment of the present invention, when the static rotor magnetic field is generated by two sets of magnetic pole forming as described previously, also the first set of magnetic pole forming means preferably comprises a set of annularly arranged PMs or a sequence of coils, wherein the annularly arranged PMs are disposed radially or tangentially mutatis mutandis to the arrangement of the abovementioned single or second set of magnetic pole forming means.

According to an embodiment of the present invention, the stable equilibrium positions are formed at angular positions of the rotor assembly with respect to the secondary stator assembly where the static rotor magnetic field, in particular its alternating magnetic poles, and the static stator magnetic field, in particular its alternating magnetic poles, have at least one, and preferably multiple, overlapping magnetic pole(s) of the opposite magnetic polarity. More/stronger stable equilibrium positions are for example obtained where more, for example all, magnetic poles of the static stator magnetic field overlap with magnetic poles of the static rotor magnetic field of opposing magnetic polarity. According to an embodiment of the present invention, the unstable equilibrium positions are formed at angular positions of the rotor assembly with respect to the secondary stator assembly where the static rotor magnetic field, in particular its alternating magnetic poles, and the static stator magnetic field, in particular its alternating magnetic poles, have at least one, and preferably multiple, overlapping magnetic poles of the same magnetic polarity. More/stronger unstable equilibrium positions are for example obtained where more, for example all, magnetic poles of the static stator magnetic field overlap with magnetic poles of the static rotor magnetic field of the same magnetic polarity. With ‘overlapping’ is meant that a magnetic pole, for example a south pole, of the rotor assembly is at the same angular position as a magnetic pole, for example also a south pole, of the secondary stator assembly. In the previous example, the overlapping poles are both south poles and thus contribute to an unstable equilibrium position. It is noted that, when at a given angular position of the rotor assembly with respect to the secondary stator assembly, the static rotor magnetic field and the static stator magnetic field have overlapping poles of both the same and the opposite polarity, the angular position is a stable equilibrium position if the number of overlapping poles of the opposite magnetic polarity is superior to the number of overlapping poles of the same magnetic polarity.

According to an embodiment of the present invention, the alternating magnetic poles of the static rotor magnetic field and the alternating magnetic poles of the static stator magnetic field are evenly distributed along respectively the rotor assembly circumference and the secondary stator assembly circumference. With ‘evenly distributed’ it is meant that every magnetic pole of the sequence of alternating magnetic poles is separated by the same angle from its neighboring magnetic poles. Preferably, the magnetic pole forming means, for example the coils or the PMs are thereto evenly distributed along the circumference of the rotor assembly and/or the secondary stator assembly. With ‘evenly distributed’ it is meant that every magnetic pole forming means is separated by its neighboring magnetic pole forming means by the same angle. The term ‘along the surface of the rotor assembly’ preferably comprises one of being provided on top of the surface of the rotor assembly and being provided in the rotor assembly adjacent to the rotor assembly surface.

According to an embodiment of the present invention, the first number of alternating magnetic poles equals the second number of alternating magnetic poles. Preferably, the number of magnetic pole forming means provided on the rotor assembly equals the number of magnetic pole forming means provided on the secondary stator assembly. Where the magnetic pole forming means of the secondary stator assembly and of the rotor assembly are PMs, the number of PMs provided on the rotor assembly for example equals the number of PMs provided on the secondary stator assembly. Where the magnetic pole forming means of the secondary stator assembly and the rotor assembly are respectively stator coils and PMs, the number of PMs provided on the rotor assembly for example equals the number of stator coils provided on the secondary stator assembly.

According to an embodiment of the present invention, the number of alternating magnetic poles and the angular distribution of the alternating magnetic poles along the circumference of the rotor assembly and of the secondary stator assembly are chosen such as to create the required torque profile adapted to the pulsating torque application. In pulsating torque applications that require constant frequency of pulses, a same number of alternating magnetic poles are preferably evenly distributed along the circumference of the rotor assembly and of the secondary stator assembly. Providing the static rotor and static stator magnetic fields with the same number of evenly distributed alternating poles has the advantage of creating a pulsating torque with a high amplitude and constant frequency.

According to an embodiment of the present invention, the rotor assembly, in particular the magnetic pole forming means of the rotor assembly, comprise(s) permanent magnets. Preferably, the degree of magnetization of the set of PMs is adapted to the required amplitude of the torque pulse produced by the magnetic torsion spring. According to an embodiment of the present invention, for example as an alternative embodiment, the rotor assembly, in particular the magnetic pole forming means of the rotor assembly, comprise(s) a plurality of rotor coils arranged to generate the static rotor magnetic field preferably by carrying a direct current.

According to an embodiment of the present invention, the secondary stator assembly, in particular the magnetic pole forming means of the secondary stator assembly, comprise(s) a set of PMs arranged annularly around the rotational axis, wherein the set of PMs of the secondary stator assembly are arranged to generate the static stator magnetic field. Preferably, the degree of magnetization of the set of PMs is adapted to the required amplitude of the torque pulse. According to an embodiment of the present invention, for example as an alternative to the preceding embodiment, the secondary stator assembly, in particular the magnetic pole forming means of the secondary stator assembly, comprise(s) a second plurality of stator coils arranged to generate the static stator magnetic field preferably by carrying a direct current. The stator coils of the secondary stator assembly are preferably single phase windings, as there is no need for providing three phase current to the secondary stator assembly. Providing a plurality of stator coils instead of a set of PMs has the advantage that the amount of direct current in the stator coils can be changed such as to change the strength of the static stator magnetic field. The strength of the static stator magnetic field determines the amplitude of the torque pulse created by the magnetic torsion spring. The strength of the static stator magnetic field is preferably initially set such as to create the required torque pulse amplitude for the driven industrial device.

According to an embodiment of the present invention, the properties of the magnetic torsion spring are tunable in terms of peak-to-peak value of the torque, i.e. its spring constant, and in terms of the angular positions of the equilibrium positions, respectively referred to as the first property and the second property. Preferably, tuning of the properties of the magnetic torsion spring means initially setting the properties of the magnetic torsion spring, i.e. prior to using the electrical machine to drive the industrial device, for example during the design of the electrical machine for a given industrial application. Alternatively or additionally, tuning of the properties of the magnetic torsion spring means resetting the properties of the magnetic torsion spring. The first property is tunable by setting, i.e. initially setting and/or resetting, the strength of the static rotor magnetic field and/or preferably by setting the strength of the static stator magnetic field. Tuning the strength of a magnetic field preferably comprises setting the degree of magnetization and/or the dimensions of the magnetic pole forming means in the rotor assembly and/or the secondary stator assembly, for example by setting the amount of direct current flow through the stator coils in the rotor assembly and/or the secondary stator assembly. The second property is tunable by setting, preferably initially setting, the number and angular positions of the alternating magnetic poles of the static rotor magnetic field, for example of the magnetic pole forming means of the static rotor magnetic field, along the rotor assembly circumference in relation to the number, and angular position of the alternating magnetic poles of the static stator magnetic field, for example of the magnetic pole forming means of the static stator magnetic field, along the secondary stator assembly circumference. The second property is preferably also tunable by setting the supply frequency of the alternating current driven through the first set of stator coils of the primary stator assembly, for example to increase or decrease the cycle rate in a definite time, for example to change the angular positions of the equilibrium positions as a function of time rather than as a function of angular position of the PM rotor assembly with respect to the stator assemblies.

According to an embodiment of the present invention, the primary and secondary stator assemblies are the same stator assembly arranged to simultaneously generate the static stator magnetic field and the rotating stator magnetic field. Physically providing a single stator assembly that carries both the stator coils of the primary stator assembly and the PMs or the stator coils of the secondary stator assembly, has the advantage that less space is occupied by the electrical machine. According to an implementation of the present embodiment, the stator coils of the primary stator assembly and the stator coils of the secondary stator assembly are the same stator coils. These stator coils for example carry a current in use that generates both the rotating stator magnetic field and the static stator magnetic field. According to an alternative embodiment of the present invention, the primary stator assembly and the secondary stator assembly are distinct stator assemblies, i.e. not the same stator assembly. The physically distinct primary and secondary stator assemblies are respectively arranged to generate the rotating stator magnetic field and the static stator magnetic field. Physically separating the primary and secondary stator assemblies enables to optimize each stator assembly with respect to their functionality. In the alternative embodiment, a further airgap is provided between the rotor assembly and the primary stator assembly such as to enable rotation of the rotor assembly with respect to the primary stator assembly.

According to an embodiment of the present invention, the primary stator assembly is positioned radially inward or outward, preferably outward with respect to the rotor assembly. In an embodiment, the secondary stator assembly is positioned radially inward or outward, preferably inward with respect to the rotor assembly. Positioning the secondary stator assembly radially inward or outward with respect to the rotor assembly, for example as opposed to axially adjacent to the rotor assembly, has the advantage that a more compact electrical machine is obtained. Preferably the rotor assembly is positioned in between the primary and secondary stator assembly. The rotor assembly is for example sandwiched between the primary and the secondary stator assemblies.

According to an embodiment of the present invention, the primary stator assembly, the rotor assembly and the secondary stator assembly are coaxially arranged and overlap in the axial direction, i.e. for a certain axial length the three assemblies are nested in the radial direction i.e. upon advancing in the radial direction starting from the rotational axis one would first encounter the primary or secondary stator assembly, one would subsequently encounter the rotor assembly, and one would finally encounter respectively the secondary or primary stator assembly. In the present embodiment the rotor assembly preferably comprises radially arranged first and second annular parts i.e. the first annular part being arranged coaxially but radially outward or inward from the second annular part. When the first annular part is provided radially outward from the second annular part, the first annular part preferably comprises the first set of magnetic pole forming means along its radially outer surface, and the second annular part preferably comprises the second set of the magnetic pole forming means along its radially inner surface. According to a further embodiment of the present invention, the properties of the magnetic torsion spring can be selected in terms of peak-to-peak value of the torque, i.e. its spring constant, by adapting the axial overlap between on the one hand the rotor assembly, in particular the second annular part of the rotor assembly, and on the other hand the secondary stator assembly. Preferably, the axial length of the rotor assembly, in particular of the second annular part of the rotor assembly, is selected, e.g. shortened or lengthened, in order to create respectively less or more axial overlap with the secondary stator assembly. Creating more or less axial overlap respectively increases or decreases the amplitude of the torque pulsation generated by the magnetic torsion spring. Preferably, the axial length of the rotor assembly, in particular of the second annular part of the rotor assembly, and of the secondary stator assembly, are substantially equal, and further preferably, the rotor assembly, in particular the second annular part of the rotor assembly, and the secondary stator assembly axially overlap along their entire axial length. According to a further embodiment of the present invention, the properties of the magnetic torsion spring are selected in terms of the average torque level of the pulsating torque profile, by adapting the axial overlap between on the one hand the rotor assembly, in particular the first annular part of the rotor assembly, and on the other hand the primary stator assembly. Preferably, the axial length of the rotor assembly, in particular of the first annular part of the rotor assembly, is selected, e.g. shortened or lengthened, in order to create respectively less or more axial overlap with the primary stator assembly. Creating more or less axial overlap respectively increases or decreases the average level of the torque in the torque pulsation generated by the magnetic torsion spring. Preferably, the axial length of the rotor assembly, in particular of the first annular part of the rotor assembly, and of the primary stator assembly, are substantially equal, and further preferably, the rotor assembly, in particular the first annular part of the rotor assembly, and the primary stator assembly axially overlap along their entire axial length. According to an embodiment of the present invention, the axial overlap between the rotor assembly in particular the first annular part of the rotor assembly, and the primary stator assembly, is different from the axial overlap between the rotor assembly in particular the second annular part and the secondary stator assembly and the secondary rotor assembly. The electrical machine of the present invention enables an easy selection of different axial lengths of the first and second annular parts of the rotor assembly, and thus of the resulting axial overlap with respectively the primary and secondary stator assembly, thanks to the modular design of the first and second annular parts i.e. because the rotor assembly can be easily assembled by interconnecting a first annular part of a given length to a second annular part of another, i.e. different, given length. According to an embodiment of the present invention, the axial length of the first annular part of the rotor assembly is thus different from the axial length of the second annular part of the rotor assembly.

According to an embodiment of the present invention, the electrical machine is a pulsating torque electrical machine, for example an electrical machine arranged to generate a pulsating torque profile for example in order to counteract the pulsating torque profile of the driven industrial device. The pulsating torque industrial device is preferably a device performing a reciprocating movement such as a weaving loom or a bale compressor. According to an embodiment, the electrical machine is connected, for example via the drive shaft, to a pulsating torque industrial device arranged to perform a reciprocating movement.

According to an embodiment of the present invention, it is clarified that the electrical machine of the present invention is arranged to fully rotate the rotor assembly along the rotational axis, i.e. to rotate the rotor assembly at least 360° around the rotational axis. The electrical machine is for example arranged to continuously revolve a crank shaft around a rotation axis. The electrical machine of the present invention is in particular not an electromagnetic switch wherein the rotation of the rotor assembly is restricted to an arc smaller than 360° around the rotational axis.

It is a further object of the present invention to use the electrical machine, wherein the primary stator assembly generates the rotating stator magnetic field, wherein the rotor assembly generates the static rotor magnetic field and wherein the secondary stator assembly generates the static stator magnetic field. It is a further object of the present invention to use the electrical machine for generating a pulsating torque. It is a further object of the present invention to use the electrical machine for driving a pulsating torque application such as for driving an industrial device performing a reciprocating movement such as a weaving loom. Preferably, the use comprises rotating the rotor assembly around the rotational axis by more than 360°.

It is a further object of the present invention to provide a kit of separate parts comprising the previously described primary stator assembly, the previously described first annular part of the rotor assembly, the previously described second part of the rotor assembly and the previously described secondary stator assembly.

Below, the second aspect of the present invention will be explained. The second aspect of the present invention relates to a machine wherein the conventional electrical machine part is not limited to a synchronous electrical machine, such as a permanent magnet synchronous electrical machine, but also comprises other conventional electrical machines such as induction machines or reluctance machines.

As stated above, the electrical machine of the present invention can preferably be summarized as a pulsating torque apparatus wherein a rotor assembly is positioned adjacent to a primary stator assembly such as to form a conventional electrical machine i.e. a conventional electromotor or a conventional electrical generator, and wherein the same rotor assembly is also positioned adjacent to a secondary stator assembly such as to form a magnetic torsion spring. The rotor assembly is thereby preferably the only rotor assembly in the electrical machine.

In the preceding part of the description, i.e. the part describing the first aspect of the invention, the conventional electrical machine part of the apparatus of the present invention was limited to a PM synchronous electrical machine. To that end, the rotor assembly comprised a single set of magnetic pole forming means, or comprised a first and a second set of magnetic pole forming means, wherein the single or two sets of magnetic pole forming means generate a static rotor magnetic field. It is a property of a PM synchronous machine that its rotor assembly is rotated by interaction of a rotating stator magnetic field, generated by a primary stator assembly, and the static rotor magnetic field, generated by the rotor assembly, in particular generated by the single set of magnetic pole forming means, or where there are two sets of magnetic pole forming means, mainly, for example solely by the first set of magnetic pole forming means. In a PM synchronous electrical machine, the single set of magnetic pole forming means or the first set of magnetic pole forming means thus enable the interaction between the rotating stator magnetic field and the rotor assembly. The single set of magnetic pole forming means or the first set of magnetic pole forming means in the PM synchronous machine can thus be referred to as an interaction component of the rotor assembly. However, in other types of electrical machines, such as induction machines or reluctance machines, the rotor assembly is not rotated due to the interaction of the rotating stator magnetic field with a static rotor magnetic field. In these other electrical machines, the rotor assembly comprises a different interaction component to ensure the interaction of the rotating stator magnetic field with the rotor assembly. In an induction machine, the interaction component is a squirrel cage provided along the rotor assembly. In a reluctance machine, the interaction component is a set of ferromagnetic pole pieces or a set of ferromagnetic flux channels provided along the surface of the rotor assembly facing the primary stator assembly. In the present second part of the description, i.e. describing the second aspect of the invention, the invention will be described in terms of a generic conventional electrical machine i.e. not limited to a (PM) synchronous electrical machine. Embodiments of the pulsating torque electrical machine presented in the preceding part of the description, i.e. describing the first aspect of the invention, are applicable mutatis mutandis to the pulsating torque electrical machine described in the present part of the description, i.e. describing the second aspect of the invention, unless otherwise provided here below.

According to an embodiment of the present invention, the electrical machine comprises a rotatable drive shaft having a rotational axis, for example extending in an axial direction, and a rotor assembly connected to the drive shaft. The rotor assembly is arranged to generate, for example in use, a static rotor magnetic field. The rotor assembly preferably comprises a set of magnetic pole forming means such as preferably a set of permanent magnets (PM), arranged annularly around the rotational axis and for example connected to the drive shaft. Preferably the set of magnetic pole forming means of the rotor assembly is arranged to generate, for example in use, the static rotor magnetic field or a part of the static rotor magnetic field. The electrical machine furthermore comprises a primary stator assembly comprising a plurality of stator coils arranged to generate, for example in use, a rotating stator magnetic field for interacting with the rotor assembly such as to rotate the rotor assembly along the rotational axis. The rotation of the rotor assembly can for example be prompted by the interaction between the rotating stator magnetic field and an interaction component provided on the rotor assembly. The interaction component of the rotor assembly is for example a single set of magnetic pole forming means of the rotor assembly or a first of two sets of magnetic pole forming means provided on the rotor assembly, thereby forming a synchronous motor/generator. Alternatively, the interaction component in the rotor assembly is for example a set of ferromagnetic pole pieces or a set of ferromagnetic flux channels provided along the surface of the rotor assembly facing the primary stator assembly, for example the radially outer surface when the primary stator assembly is positioned radially outward from the rotor assembly, thereby forming a reluctance motor/generator. Alternatively, the interaction component of the rotor assembly is for example a squirrel cage provided along the rotor assembly surface facing the primary stator assembly, for example the radially outer surface when the primary stator assembly is positioned radially outward from the rotor assembly, thereby forming an induction motor/generator. The electrical machine furthermore comprises a secondary stator assembly arranged to generate, for example in use, a static stator magnetic field. The secondary stator assembly preferably comprises a further set of magnetic pole forming means, arranged annularly around the rotational axis, but disconnected from the drive shaft. Preferably, the further set of magnetic pole forming means of the secondary stator assembly is arranged to generate, for example in use, the static stator magnetic field. The electrical machine comprises a magnetic torsion spring formed by the interaction of the static stator magnetic field with the static rotor magnetic field. The different types of electrical machines as described above have the same advantages as the synchronous pulsating torque electrical machines described under the preceding part of the description, i.e. the part describing the first aspect of the invention.

According to an embodiment of the present invention, the static rotor magnetic field is generated, i.e. solely generated, by a single set of magnetic pole forming means annularly arranged around the rotational axis, for example a single set of PM annularly arranged around the rotational axis. In a first implementation of the present embodiment, the static rotor magnetic field generated by the single set of magnetic pole forming means interacts with both the rotating stator magnetic field and the static stator magnetic field such as to respectively form the motor/generator and the magnetic torsion spring. In an implementation, the single set of magnetic pole forming means is provided along the surface of the rotor assembly facing the primary stator assembly. The term ‘along the surface of the rotor assembly’ preferably comprises one of being provided on top of the surface of the rotor assembly and being provided in the rotor assembly adjacent to the rotor assembly surface. Preferably however, the single set of magnetic pole forming means is provided substantially centrally of the rotor assembly i.e. substantially centrally between the surface of the rotor assembly facing the primary stator assembly and the surface of the rotor assembly facing the secondary stator assembly, for example provided substantially centrally in the radial direction in case the rotor assembly and the two stator assemblies are radially nested. This arrangement enables the static rotor magnetic field to optimally interact with both the rotating stator magnetic field and the static stator magnetic field. In this first implementation, the single set of magnetic pole forming means of the rotor assembly is the interaction component of the rotor assembly. In a second implementation of the present embodiment the static rotor magnetic field generated by the single set of magnetic pole forming means interacts primarily, preferably substantially solely, with the static stator magnetic field. Preferably, the single set of magnetic pole forming means is therefore provided substantially closer to the secondary stator assembly than to the primary stator assembly. Preferably, the single set of magnetic pole forming means is provided adjacent to, for example along, the surface of the rotor assembly facing the secondary stator assembly, for example the radially inner surface of the rotor assembly when the secondary stator assembly is positioned radially inward of the rotor assembly. This arrangement enables the static rotor magnetic field to optimally interact with the static stator magnetic field whilst minimally interacting with the rotating stator magnetic field. In this second implementation, the single set of magnetic pole forming means are preferably separated from the surface of the rotor assembly facing the primary stator assembly, by a layer having an increased reluctance such as a layer of air or adhesive. In this second implementation, the interaction component of the rotor assembly is not the single set of magnetic pole forming means of the rotor. In this second implementation, the set of ferromagnetic pole pieces or the set of ferromagnetic flux channels is the interaction component of the rotor assembly, thereby forming a reluctance machine. Alternatively, the squirrel cage is the interaction component of the rotor assembly, thereby forming an induction machine.

According to an embodiment of the present invention, the static rotor magnetic field is generated by two sets of magnetic pole forming means annularly arranged around the rotational axis, such as two sets of PM annularly arranged around the rotational axis, as described under the preceding part of the description, i.e. the part describing the first aspect of the invention. In this embodiment, the first set of magnetic pole forming means of the rotor assembly is the interaction component of the rotor assembly, thereby forming a synchronous electrical machine.

According to an embodiment of the present invention, the rotor assembly comprises first and second annular parts as described in the preceding part of the description, i.e. the part describing the first aspect of the invention, and preferably the first annular part of the rotor assembly comprises the interaction component of the rotor assembly. Therefore, the second annular part of the rotor assembly preferably comprises where applicable, i.e. where the rotor assembly only comprises a single set of magnetic pole forming means, the single set of magnetic pole forming means not acting as an interaction component, or where applicable, i.e. where the rotor assembly comprises two sets of magnetic pole forming means, the second set of magnetic pole forming means, preferably, where applicable the single set of PMs, or where applicable the second set of PMs. It has been found that the present embodiment enables to create a modular electrical machine, as described under the preceding part of the description, i.e. the part describing the first aspect of the invention. As described in preceding part of the description, the requirements of a pulsating torque electrical machine for a particular industrial application can indeed be categorized based on two dominant parameters. The first parameter is the required angular velocity of the industrial application. The motor/generator part of the electrical machine, i.e. the part formed by the primary stator assembly and the first annular part of the rotor assembly, can be optimized to function at the required angular velocity. The rotating stator magnetic field of the primary stator assembly, in particular as observed in the airgap between the rotor assembly and the primary stator assembly, is for example provided with a required number of alternating magnetic poles, in accordance with the established relation between the synchronous speed of an electrical machine on the one hand and the electrical driving frequency and the inverse of the number of magnetic pole pairs on the other hand. The interaction component of the first annular part of the rotor assembly is adapted accordingly. The second parameter is the required periodicity of the pulsating torque profile per revolution of the rotor assembly. The rotor assembly and the secondary stator assembly are arranged such as to create the required amount of equilibrium positions, wherein the amount of stable equilibrium positions should be chosen equal to the required periodicity.

### DRAWINGS

FIG. 1 depicts a cross-sectional view of an electrical machine according to one embodiment;

FIG. 2 shows that the pulsating torque profile that the magnetic torsion spring produces onto the driven shaft, is chosen such as to substantially cancel out the pulsating torque profile of the pulsating torque industrial application driven via the driven shaft.

FIG. 3 depicts a graph of the torque produced by the electrical machine according to one embodiment of the present invention as a function of the rotation of the rotor assembly with respect to the secondary stator assembly.

FIG. 4 depicts a cross-sectional view of an electrical machine according to a further embodiment.

FIG. 5a-5d show four embodiments of the electrical machine wherein the modularity of the electrical machine is illustrated in a cross-section taken along an axial plane.

FIGS. 6a-6c show three embodiments of the electrical machine wherein the modularity of the electrical machine is illustrated in a cross-section taken along a plane comprising the rotation axis.

### BRIEF DESCRIPTION OF THE DRAWINGS

The present invention will be described with respect to particular embodiments and with reference to certain drawings, but the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention. Furthermore, the terms first and second, in the description and in the claims, are used for distinguishing between similar elements and not necessarily for describing a sequential or chronological order. The terms are interchangeable under appropriate circumstances and the embodiments of the invention can operate in other sequences than described or illustrated herein.

Furthermore, the various embodiments, although referred to as “preferred” are to be construed as exemplary manners in which the invention may be implemented rather than as limiting the scope of the invention.

The term “comprising”, used in the claims, should not be interpreted as being restricted to the elements or steps listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising A and B” should not be limited to devices consisting only of components A and B, rather with respect to the present invention, the only enumerated components of the device are A and B, and further the claim should be interpreted as including equivalents of those components.

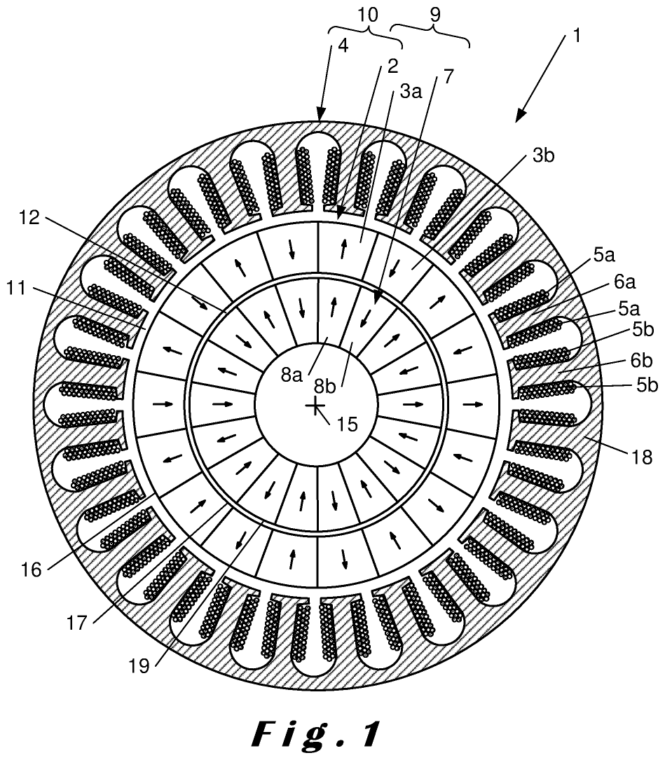

FIG. 1 depicts a cross-sectional view of an electrical machine 1 according to one embodiment. The electrical machine 1 is illustrated in a cross-section taken along an axial plane (i.e. a plane perpendicular to the axial direction). The electrical machine 1 is a pulsating torque electrical machine 1, for example a pulsating torque electromotor for driving an industrial device exhibiting reciprocating movement such as a weaving loom. The electrical machine 1 comprises a rotor assembly 2 connected to a rotatable drive shaft (not shown) having a rotational axis 15. The rotor assembly 2 comprises an annular component formed by a set of PMs 3a, 3b arranged annularly around the rotational axis 15, wherein the set of PMs 3a, 3b of the rotor assembly 2 are arranged to generate a static rotor magnetic field. Each PM 3a, 3b is radially magnetized, thereby creating a magnetic pole pair wherein the magnetic north pole and the magnetic south pole are radially disposed with respect to each other. Neighboring PMs 3a, 3b have an opposite magnetization vector. The magnetization direction of the PM 3a is directed radially outward, whilst the magnetization direction of the neighboring PM 3b is directed radially inward. The static rotor magnetic field emanates from the PMs 3a, 3b of the PM rotor assembly 2 and travels to first 11 and second 12 airgaps provided adjacent to respectively the outer 16 and inner 17 radial surfaces of the rotor assembly 2. Along the circumference of the inner radial surface 17 of the rotor assembly 2 alternating magnetic poles are present, i.e. a sequence of alternating magnetic north and magnetic south poles are present, for example observed in the second airgap 12 adjacent the inner radial surface 17 of the rotor assembly 2. The alternating magnetic poles of the rotor assembly 2 are evenly distributed along the circumference of the inner radial surface 17 of the rotor assembly 2. The eighteen alternating magnetic poles along the inner radial surface 17 of the rotor assembly 2 thus each span an arc of 20°. The electrical machine 1 further comprises two physically distinct stator assemblies, in particular a primary stator assembly 4 and a secondary stator assembly 7. Both stator assemblies 4, 7 are positioned concentrically with the rotor assembly 2. The primary stator assembly 4 is positioned radially outward from the outer radial surface 16 of the rotor assembly 2. The secondary stator assembly 7 is positioned radially inward from the inner radial surface 17 of the rotor assembly 2. The primary stator assembly 4 is separated from the outer radial surface 16 of the rotor assembly 2 by the first airgap 11. The secondary stator assembly 7 is separated from the inner radial surface 17 of the rotor assembly 2 by the second airgap 12. The airgaps 11, 12 enable the rotor assembly 2 to rotate with respect to the stator assemblies 4, 7. The primary stator assembly 4, the secondary stator assembly 7 and the rotor assembly 2 are nested i.e. the rotor assembly 2 lies in between the two stator assemblies 4, 7. The stator assemblies 4, 7 are static, i.e. are not arranged to rotate in use. The primary stator assembly 4 comprises a primary stator yoke 18 provided with a multitude of stator teeth 6a, 6b. Around each stator tooth 6a, 6b a stator coil 5a, 5b is wounded. The stator coils 5a, 5b are wound in a 3 phase winding pattern and are arranged to, in use, generate a rotating stator magnetic field. The rotating stator magnetic field, in use, is present within the first airgap 11 and interacts with the static rotor magnetic field of the rotor assembly 2 such as to rotate the rotor assembly 2 along the rotational axis 15. The interaction of the static rotor magnetic field and the rotating stator magnetic field for example forms a conventional electromotor 10. The secondary stator assembly 7 comprises an annular component formed by a second set of PMs 8a, 8b arranged annularly around the rotational axis 15, wherein the set of PMs 8a, 8b of the secondary stator assembly 7 are arranged to generate a static stator magnetic field. Each PM 8a, 8b is radially magnetized, thereby creating a magnetic pole pair wherein the magnetic north pole and the magnetic south pole are radially disposed with respect to each other. Neighboring PMs 8a, 8b have an opposite magnetization vector. The magnetization direction of the PM 8a is directed radially outward, whilst the magnetization direction of the neighboring PM 8b is directed radially inward. The static stator magnetic field generated by the PMs 8a, 8b of the secondary stator assembly 7 is present in the second airgap 12. Along the circumference of the outer radial surface 19 of the secondary stator assembly 7, alternating magnetic poles are present, i.e. a sequence of alternating magnetic north and magnetic south poles is present, for example observed in the second airgap 12 adjacent the outer radial surface 19 of the secondary stator assembly 7. The alternating magnetic poles of the secondary stator assembly 7 are evenly distributed along the circumference of the outer radial surface 19 of the secondary stator assembly 7. The eighteen alternating magnetic poles along the outer radial surface 19 of the secondary stator assembly 7 thus each span an arc of 20°. The static stator magnetic field, in use, is present within the second airgap 12 and interacts with the static rotor magnetic field of the rotor assembly 2 such as to create a magnetic torsion spring 9.

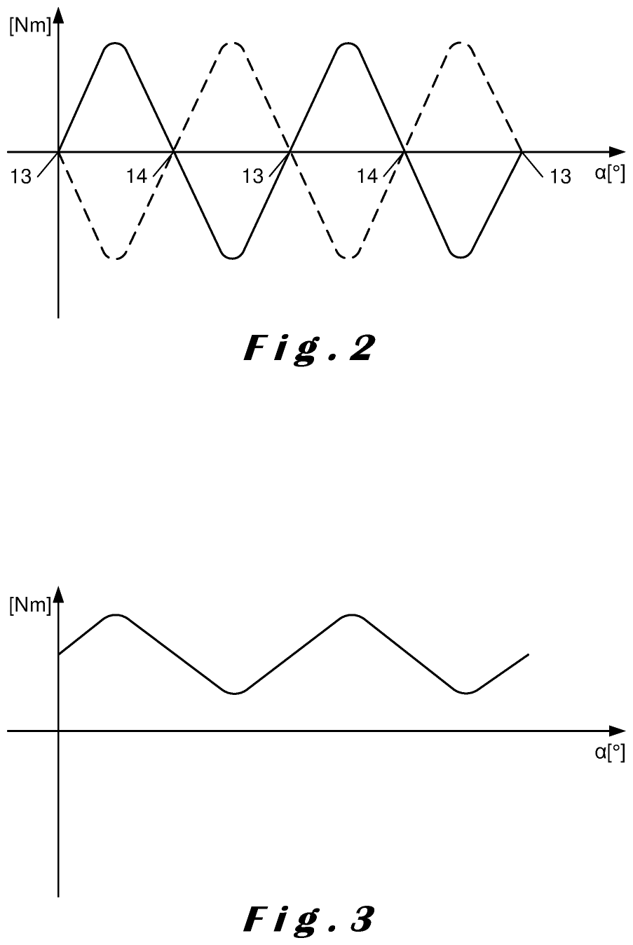

FIG. 2 shows that the pulsating torque profile that the magnetic torsion spring 9, such as the magnetic torsion spring 9 of FIG. 1, exerts onto the drive shaft, is chosen such as to substantially cancel out the pulsating torque profile of the pulsating torque industrial application driven by the drive shaft. The graph depicts the torque, in Nm, along the vertical axis, in function of the degrees of rotation of the rotor assembly 2 with respect to the secondary stator assembly 7 along the horizontal axis. The solid line depicts the torque exerted by the pulsating torque industrial device on the drive shaft, and thus on the rotor assembly 2. The dashed line depicts the torque exerted on the drive shaft by the magnetic torsion spring 9 due to the interaction of the static rotor and static stator magnetic fields. The electrical machine 1 of FIG. 1 is shown at 0° rotation of the rotor assembly 2 with respect to the secondary stator assembly 7. The positive degrees of rotation are defined as a clockwise rotation of the rotor assembly 2 with respect to the secondary stator assembly 7. Positive torque is defined as the torque accelerating the rotor assembly 2 along the positive direction of rotation.

In the graph of FIG. 2, the solid line follows a regular wave pattern, crossing the zero torque axis at regular intervals. The shape of the wave, for example when the wave is sinusoidal its amplitude and frequency, is determined by the industrial device that is to be driven by the electrical machine 1. As shown in the first half wavelength of the solid line, the industrial device exerts positive torque to the drive shaft and thus to the rotor assembly 2 for example when the industrial device releases potential energy. As an example, a weaving loom can drop down from an elevated position to a lower position, thereby releasing its potential energy and generating positive torque on the drive shaft and thus on the rotor assembly 2. Subsequently, as shown in the second half wavelength of the solid line, the industrial device exerts a negative torque on the rotor assembly 2 for example when the industrial device stores potential energy. As an example, the weaving loom has to be lifted from the lower position towards the elevated position, thereby storing potential energy and generating negative torque on the drive shaft and thus on the rotor assembly 2. The reciprocating movement of the pulsating industrial device is repeated in a regular manner.

In the graph of FIG. 2, the dashed line follows a regular wave pattern, crossing the zero torque axis at regular intervals. In the present example, the angular positions of the rotor assembly 2 with respect to the secondary stator assembly 7 where the dashed line crosses the zero torque axis are referred to as equilibrium positions 13, 14. These equilibrium positions 13, 14 occur at angular positions of the rotor assembly 2 with respect to the secondary stator assembly 7 where a substantial number of the PMs 3a, 3b of the PM rotor assembly 2 coincide with the PMs 8a, 8b of the secondary stator assembly 7. In the electrical machine 1 of FIG. 1 the equilibrium positions occur every 20°. The rotor assembly 2 is rotatable towards and past any given one of said equilibrium positions 13, 14 in a springing manner via magnetic forces created by said interaction of the static rotor and static stator magnetic fields. The magnetic torsion spring 9 is arranged to transduce kinetic energy into potential energy and vice versa. Stable 13 and unstable 14 equilibrium positions are for example formed were the potential energy stored in the magnetic torsion spring 9 is respectively at a minimum and at a maximum. Referring to the electrical machine 1 of FIG. 1, the stable equilibrium positions 13 occur where the PMs 3a, 3b of the rotor assembly 2 with a magnetization vector respectively directed radially outward and radially inward coincide with the PMs 8a, 8b of the rotor assembly 2 with a magnetization vector respectively directed radially outward and radially inward. The unstable equilibrium positions 14 occur where the PMs 3a, 3b of the rotor assembly 2 with a magnetization vector respectively directed radially outward and radially inward coincide with the PMs 8a, 8b of the rotor assembly 2 with a magnetization vector respectively directed radially inward and radially outward.

The shape of the dashed line, is chosen such as to oppose the shape of the solid line which is determined by the industrial device to be driven. In particular the shape of the dashed line is obtained by inverting the values of the vertical axis of the solid line. The shape of the dashed line can be adapted by the person skilled in the art by adapting the characteristics of the magnetic torsion spring 9, for example by changing the number, positioning and strength of the PMs 3a, 3b of the rotor assembly 2 and of the PMs 8a, 8b of the secondary stator assembly 7. It has been found that by opposing the shape of the dashed line with respect to the solid line, the torque exerted on the rotor assembly 2 is substantially averaged out. Discrepancies in the solid and dashed lines, as well as frictional losses, have to be compensated by the interaction of the first static field and the second rotating field, i.e. by the electromotor 10.

In practice, the pulsating torque industrial device will require an offset torque component to be driven, i.e. to drive a given load at a given speed, in addition to the pulsating torque component. Therefore, the apparatus of the present invention is an electrical machine 1 such as an electromotor 10 with an integrated magnetic torsion spring 9, wherein the magnetic torsion spring 9 has a pulsating torque profile for example as described in FIG. 2. FIG. 3 depicts an illustrative graph of the torque produced by the electrical machine 1 according to one embodiment of the present invention as a function of the rotation of the rotor assembly 2 with respect to the secondary stator assembly 7. The torque profile produced by the electrical machine 1 comprises a substantially constant offset torque component superimposed with a pulsating torque component.

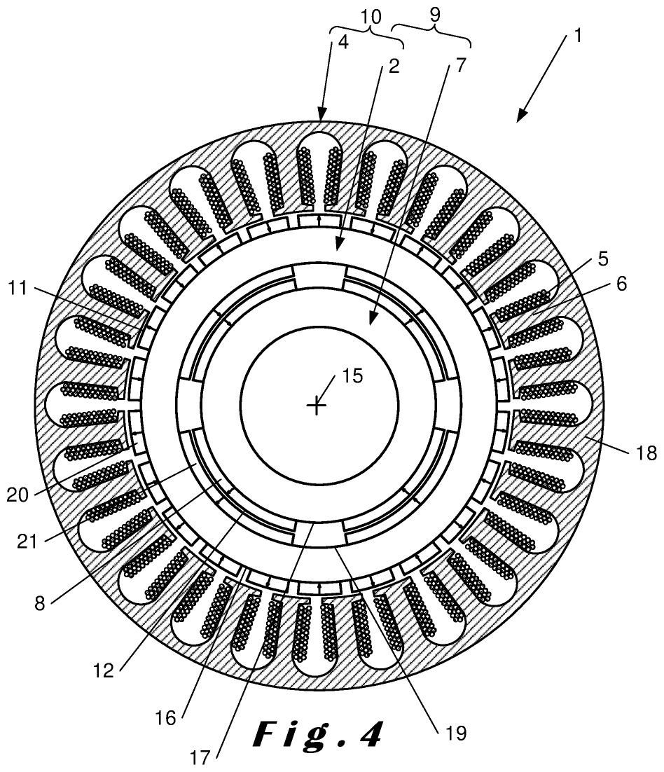

FIG. 4 depicts an electrical machine according to a further embodiment illustrated in a cross-section taken along an axial plane (i.e. a plane perpendicular to the axial direction). Corresponding features between the electrical machine 1 depicted in FIG. 4 and the electrical machine 1 depicted in FIG. 1 have been given the same reference number. The electrical machine depicted in FIG. 4 differs from the one depicted in FIG. 1 principally by the construction of the rotor assembly 2. The rotor assembly 2 in FIG. 1 comprises a single set of annularly arranged magnetic pole forming means, i.e. permanent magnets 3, which generates the static rotor magnetic field. The rotor assembly in FIG. 4 comprises two sets of annularly arranged magnetic pole forming means 20, 21, i.e. permanent magnets. The first set of PMs 20 is provided along the circumference of the rotor assembly 2 defined by the surface of the rotor assembly 2 delimiting the airgap 11. In the present embodiment, the term ‘along the surface of the rotor assembly’ comprises being provided on top of the surface of the rotor assembly. This first set of PMs 20 is arranged in proximity, i.e. substantially adjacent, to the primary stator assembly 4, such that the part of the static rotor magnetic field generated by the first set of PMs 20 optimally interacts with the rotating stator magnetic field generated by the plurality of stator coils 5 of the primary stator assembly 4. The second set of PMs 21 is provided along the circumference of the rotor assembly 2 defined by the surface of the rotor assembly 2 delimiting the airgap 12. In the present embodiment, the term ‘along the surface of the rotor assembly’ comprises being provided on top of the surface of the rotor assembly. This second set of PMs 21 is arranged in proximity, i.e. substantially adjacent, to the secondary stator assembly 7, such that the part of the static rotor magnetic field generated by the second set of PMs 21 optimally interacts with the static stator magnetic field generated by the magnetic pole forming means, i.e. the permanent magnets 8 of the secondary stator assembly 7.

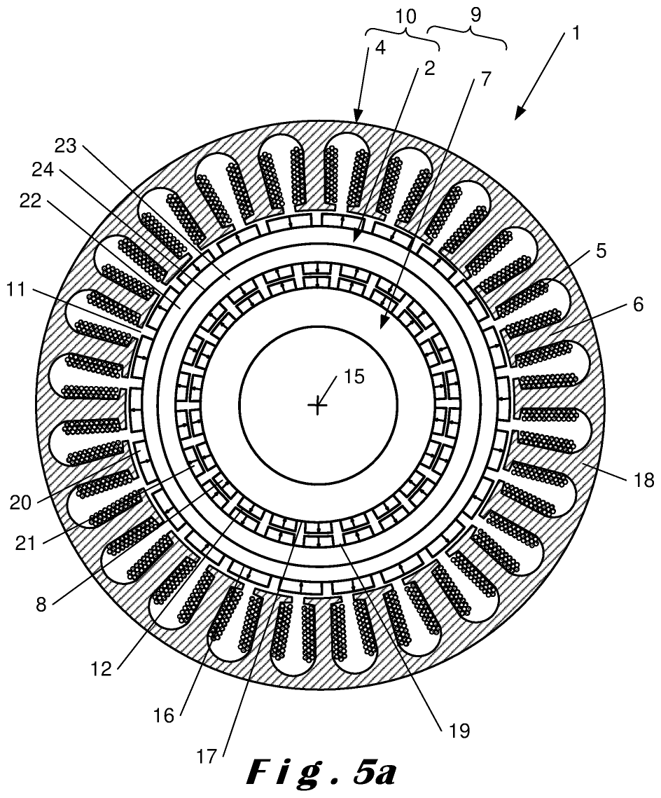

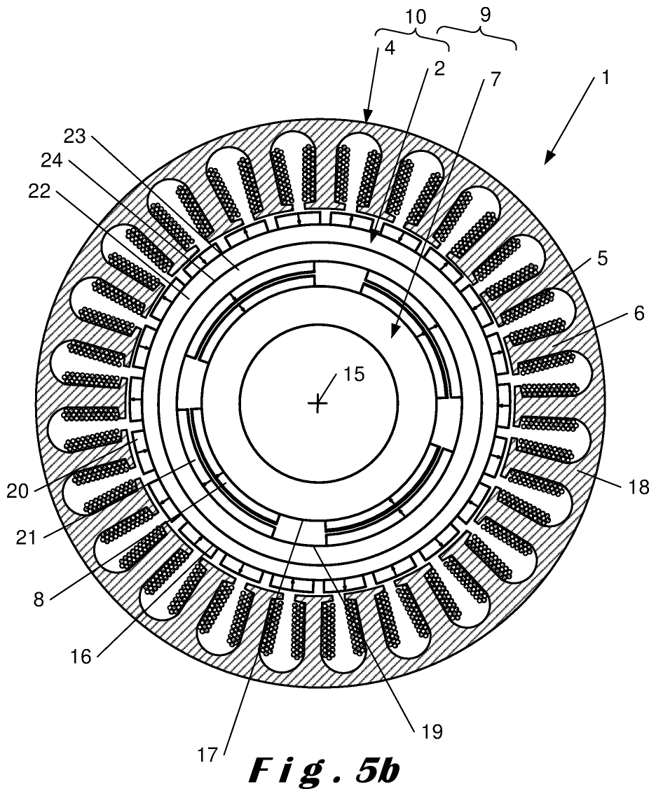

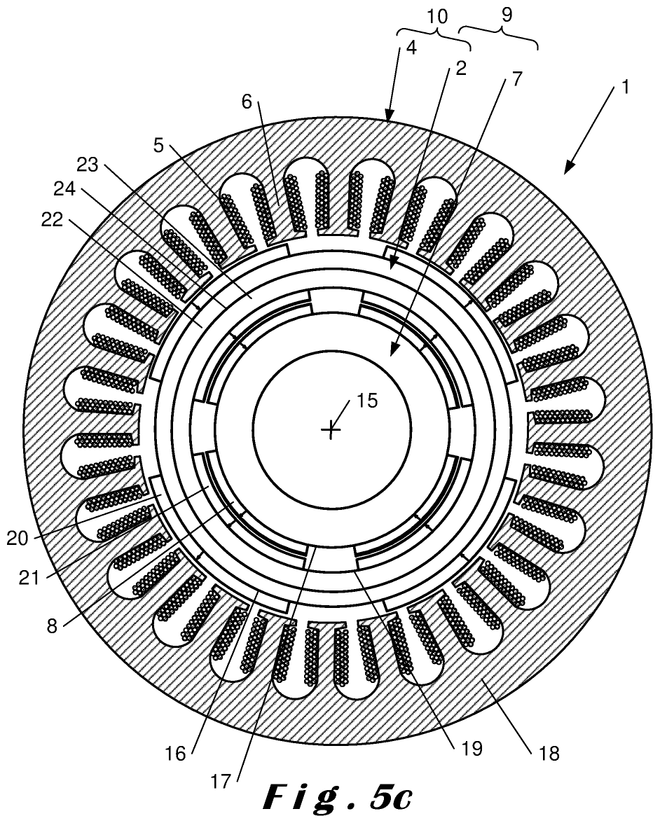

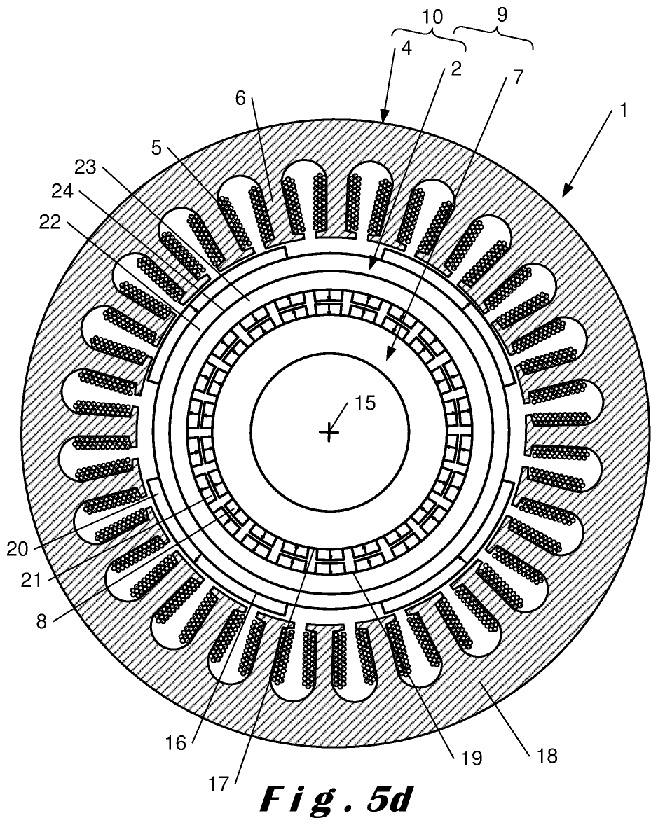

The rotor assemblies 2 of the electrical machines 1 depicted in FIGS. 1 and 4 are formed of a single annular part. It is however possible to provide the rotor assembly 2 out of a first radially outward annular part and a second radially inward annular part interconnected to the first annular part 22 and a second annular part 23. This is shown in the FIGS. 5a-5d.

FIG. 5a-5d show four embodiments of the electrical machine 1 is illustrated in a cross-section taken along an axial plane (i.e. a plane perpendicular to the axial direction). The electrical machines 1 from the FIGS. 5a-5d differ from the electrical machine 1 from FIG. 4 in at least that the rotor assembly 2 comprises two interconnected annular parts, i.e. a first annular part 22 interconnected to a second annular part 23. The first annular part 22 is provided radially outward from the second annular part 23. The radially inward surface of the first annular part 22 is positioned adjacent to the radially outward surface of the second annular part 23, and is attached to the radially outward surface of the second annular part 23 by an interconnection means 24 such as an adhesive layer or a mechanical interconnection. The interconnection means 24 has a reluctance which is higher than the reluctance of the core material of the first annular part 22 and of the second annular part 23, thereby ensuring the optimal confinement of the magnetic fluxes to each of the annular parts 22, 23. The first annular part 22 comprises the interaction component, in the present embodiment being the first set of magnetic pole forming means 20, in particular the first set of permanent magnets 20. This first set of PMs 20 is annularly arranged around the rotation axis 15 along the radially outward surface of the first annular part 22 i.e. the surface facing towards the primary stator assembly 4 i.e. the surface of the first annular part 22 delimiting the airgap between the primary stator assembly 4 and the rotor assembly 2. In particular, the first set of PMs 20 is provided on, i.e. on top of, the radially outward surface of the first annular part 22. The part of the static rotor magnetic field generated by the first set of PMs 20 is optimally confined in the first annular part 22 due to the relatively high reluctance of the interconnection means 24. The part of the static rotor magnetic field generated by the first set of PMs 20 is referred to as the interacting magnetic field of the rotor assembly, as it is this part of the static rotor magnetic field that optimally interacts with the rotating stator magnetic field thereby causing the rotation of the rotor assembly 2. The second annular part 23 of the rotor assembly 2 comprises the second set of magnetic pole forming means 21, in particular the second set of permanent magnets 21. This second set of PMs 21 is annularly arranged around the rotation axis 15 along the radially inward surface of the second annular part 23 i.e. the surface of the second annular part 23 facing towards the secondary stator assembly 7 i.e. the surface of the second annular part 23 delimiting the airgap between the secondary stator assembly 7 and the rotor assembly 2. In particular, the second set of PMs 21 is provided on, i.e. on top of, the radially inward surface of the second annular part 23. The part of the static rotor magnetic field generated by the second set of PMs 21 is optimally confined in the second annular part 23 due to the relatively high reluctance of the interconnection means 24. The part of the static rotor magnetic field generated by the second set of PMs 21 optimally interacts with the static stator magnetic field thereby creating the magnetic torsion spring. The electrical machines 1 shown in FIGS. 5a-5d depict the modularity of the electrical machines 1 of the present invention. It has been found that the requirements of a pulsating torque electrical machine for a particular industrial application can be categorized based on two dominant parameters, i.e. the required angular velocity (the amount of RPM) and the required periodicity of the pulsating torque profile per revolution of the rotor assembly 2. The required dominant parameters of the electrical machine 1 of the present invention can be easily selected by providing the electrical machine with the correct first annular part 22 and the correct second annular part 23. The first annular part 22, comprising the interaction component, can be selected to provide the required angular velocity of the electrical machine 1. By providing a first annular part 22 wherein the interaction component comprises a low amount of PMs 20 of alternating polarity, one provides an electrical machine 1 with a high angular velocity and vice versa. The electrical machines 1 depicted in FIGS. 5c and 5d comprise a first annular part 22 selected for high angular velocity i.e. with a low amount of PMs 20, whereas the electrical machines 1 depicted in FIGS. 5a and 5b comprise a first annular part 22 selected for low angular velocity i.e. with a higher amount of PMs 20. In any case, the primary stator assembly 4 must be selected such as to optimally interact with the first annular part 22 of the rotor assembly 2, i.e. by creating the corresponding amount, for example the same amount, of alternating magnetic poles in the rotating stator magnetic field. Additionally, the yoke 18 of the primary stator assembly 4 in the ‘low angular velocity’ electrical machines 1 depicted in FIGS. 5a and 5b can be made thinner than the yoke 1 of the primary stator assembly 4 in the ‘high angular velocity’ electrical machines 1 depicted in FIGS. 5c and 5d′. The second annular part 23, comprising the second set of PMs 21, can be selected to provide the required periodicity of the pulsating torque profile per revolution of the rotor assembly 2. By providing a second annular part 23 with a low amount of PMs 21 a low frequency torque pulsation can be achieved and vice versa. The electrical machines 1 depicted in FIGS. 5b and 5c comprise a second annular part 23 selected for low frequency torque pulsations i.e. with a low amount of PMs 21, whereas the electrical machines 1 depicted in FIGS. 5a and 5d comprise a second annular part 23 selected for high frequency torque pulsations i.e. with a higher amount of PMs 21. In any case, the secondary stator assembly 7 must be selected such as to optimally interact with the second annular part 23 of the rotor assembly 2, i.e. by creating the corresponding amount, for example the same amount, of alternating magnetic poles in the static stator magnetic field. In particular as shown in the FIGS. 5a-5d, the amount and angular positions of the PMs 8 of alternating polarity provided on the secondary stator assembly 7 are identical to the amount and angular positions of the PMs 21 of alternating magnetic polarity provide on the second annular part 23 of the rotor assembly 2.

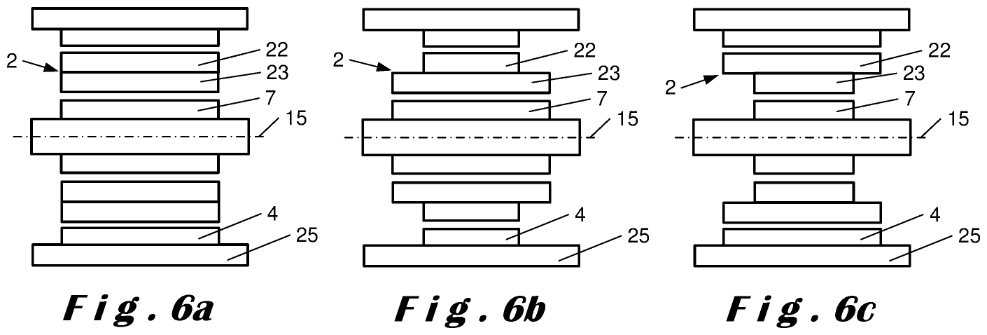

FIGS. 6a-6c show three embodiments of the electrical machine 1 illustrated in a cross-section taken along a plane comprising the rotation axis 15. The electrical machine 1 depicted in FIGS. 6a-6c is for example any one of the electrical machines shown in FIG. 5. FIGS. 6a-6c shows the electrical machine 1 enclosed by a stator housing 25 for example comprising cooling means for cooling the primary stator assembly 4. In the electrical machines 1 depicted in FIGS. 6a-6c, the primary stator assembly 4, the rotor assembly 2 and the secondary stator assembly 7 are radially nested, i.e. upon advancing in the radial direction starting from the rotational axis 15 one would first encounter the secondary stator assembly 7, one would subsequently encounter the rotor assembly 2, and one would finally encounter the primary stator assembly 4. The rotor assembly 2 comprises two interconnected annular parts 22, 23. The primary stator assembly 4 is radially nested with the rotor assembly 2, in particular with its first annular part 22, over a given axial length, referred to as the axial overlap between the primary stator assembly 4 and the rotor assembly 2. The secondary stator assembly 7 is radially nested with the rotor assembly 2, in particular with its second annular part 23, over a given axial length, referred to as the axial overlap between the secondary stator assembly 7 and the rotor assembly 2. In the electrical machine 1 depicted in FIG. 6a, the axial overlap between the primary stator assembly 4 and the rotor assembly 2 is equal to the axial overlap between the secondary stator assembly 7 and the rotor assembly 2. In the electrical machine 1 depicted in FIG. 6b, the axial overlap between the primary stator assembly 4 and the rotor assembly 2 is smaller than the axial overlap between the secondary stator assembly 7 and the rotor assembly 2. The electrical machine 1 depicted in FIG. 6b therefore exhibits an increased influence of the pulsating torque of the magnetic torsion spring and a decreased influence of the average torque of the electromotor in comparison to the same electrical machine 1 provided with an axial overlap as depicted in FIG. 6a. In the electrical machine 1 depicted in FIG. 6c, the axial overlap between the primary stator assembly 4 and the rotor assembly 2 is larger than the axial overlap between the secondary stator assembly 7 and the rotor assembly 2. The electrical machine 1 depicted in FIG. 6c therefore exhibits a decreased influence of the pulsating torque of the magnetic torsion spring and an increased influence of the average torque of the electromotor in comparison to the same electrical machine 1 provided with an axial overlap as depicted in FIG. 6a. The axial lengths of the first annular part 22 and the second annular part 23 are substantially equal to respectively the axial lengths of the primary stator assembly 4 and the secondary stator assembly 7. The first annular part 22 axially overlaps with the primary stator assembly 4 over its entire axial length. The second annular part 23 axially overlaps with the secondary stator assembly 7 over its entire axial length. It is clear that the present embodiment can be easily obtained by interconnecting first and second annular parts 22, 23 having different axial lengths. In a further embodiment (not shown), the desired axial overlaps are obtained by merely selecting different axial lengths of the first annular part 22 and the second annular part 23, i.e. whilst providing the primary stator assembly 4 with an axial length substantially equal to the axial length of the secondary stator assembly 7.

1. An electrical machine (1) comprising:
a rotatable drive shaft having a rotational axis (15);
a rotor assembly (2) connected to the drive shaft, the rotor assembly (2) arranged to generate a static rotor magnetic field; wherein the rotor assembly is arranged to rotate at least 360° around the rotational axis,
a primary stator assembly (4), comprising a plurality of stator coils (5a, 5b) arranged to generate a rotating stator magnetic field for interacting with the static rotor magnetic field of the rotor assembly (2) such as to rotate the rotor assembly (2) along the rotational axis (15), and
a secondary stator assembly (7) arranged to generate a static stator magnetic field;
wherein the electrical machine (1) comprises a magnetic torsion spring (9) formed by the interaction of the static stator magnetic field with the static rotor magnetic field, wherein the magnetic torsion spring applies a pulsating torque profile on the rotor assembly, the pulsating torque profile having a periodicity of at least one period per revolution of the rotor assembly.

2. The electrical machine (1) of claim 1 wherein the static stator magnetic field and the static rotor magnetic field are movable relative to one another and are forming a plurality of stable equilibrium positions (13) and a plurality of unstable equilibrium positions (14), said plurality of stable and unstable equilibrium positions (13, 14) located around the rotational axis (15) and said plurality of unstable equilibrium positions (14) located interspersed between the stable equilibrium positions (13), wherein the rotor assembly (2) is rotatable towards and past any given one of said equilibrium positions (13, 14) in a springing manner via magnetic forces created by said interaction of the static rotor and static stator magnetic fields.

3. The electrical machine (1) according to claim 1 wherein the static rotor magnetic field comprises a first number of alternating magnetic poles distributed along the rotor assembly (2) circumference defined by the surface of the rotor assembly (2) delimiting the airgap between the rotor assembly (2) and the secondary stator assembly (7), and wherein the static stator magnetic field comprises a second number of alternating magnetic poles distributed along the secondary stator assembly (7) circumference defined by the surface of the secondary stator assembly (7) delimiting the airgap between the rotor assembly (2) and the secondary stator assembly (7).

4. The electrical machine (1) according to claim 1, wherein stable equilibrium positions (13) are formed at angular positions of the rotor assembly (2) with respect to the secondary stator assembly (7) where the static rotor magnetic field and the static stator magnetic field have at least one overlapping magnetic pole of the opposite magnetic polarity and wherein unstable equilibrium positions (14) are formed at angular positions of the rotor assembly (2) with respect to the secondary stator assembly (7) where the static rotor magnetic field and the static stator magnetic field have at least one overlapping magnetic pole of the same magnetic polarity.

5. The electrical machine (1) according to claim 3, wherein the alternating magnetic poles of the static rotor magnetic field and the alternating magnetic poles of the static stator magnetic field are evenly distributed along respectively the rotor assembly (2) circumference defined by the surface of the rotor assembly (2) delimiting the airgap between the rotor assembly (2) and the secondary stator assembly (7), and the secondary stator assembly (7) circumference defined by surface of the secondary stator assembly (7) delimiting the airgap between the rotor assembly (2) and the secondary stator assembly (7).

6. The electrical machine (1) according to claim 3, wherein the first number of alternating magnetic poles equals the second number of alternating magnetic poles.

7. The electrical machine (1) according to claim 1, wherein the secondary stator assembly (7) comprises a set of PMs (8a, 8b) arranged annularly around the rotational axis (15), wherein the set of PMs (8a, 8b) of the secondary stator assembly (7) is arranged to generate the static stator magnetic field.

8. The electrical machine (1) according to claim 1 wherein the primary stator assembly (4) and the secondary stator assembly (7) are distinct stator assemblies.

9. The electrical machine (1) according to claim 8, wherein the primary stator assembly (4) is positioned radially outward with respect to the rotor assembly (2) and wherein the secondary stator assembly (7) is positioned radially inward with respect to the rotor assembly (2).

10. (canceled)

11. The electrical machine (1) according to claim 1 wherein the electrical machine (1) is a pulsating torque electrical machine.

12. The electrical machine (1) according to claim 1, wherein the rotor assembly (2) comprises a single set of magnetic pole forming means (3) arranged annularly around the rotational axis (15), wherein the single set of magnetic pole forming means (3) is arranged to generate the static rotor magnetic field, and wherein the single set of magnetic pole forming means (3) are permanent magnets.

13. The electrical machine (1) according to claim 1, wherein the rotor assembly (2) comprises a first set of magnetic pole forming means (20) arranged annularly around the rotational axis (15) and arranged along the surface (16) of the rotor assembly (2) facing the primary stator assembly (4), wherein the rotor assembly (2) comprises a second set of magnetic pole forming means (21) arranged annularly around the rotational axis (15) and arranged along the surface (17) of the rotor assembly (2) facing the secondary stator assembly (7), wherein the first and second sets of magnetic pole forming means (21, 22) are arranged to generate the static rotor magnetic field together, and wherein the first and second sets of magnetic pole forming means (21, 22) are permanent magnets.

14. The electrical machine (1) according to claim 1 wherein the rotor assembly (2) comprises a first annular part (22) interconnected to a second annular part (23) by an interconnection means (24), wherein the first annular part (22) comprises the first set of magnetic pole forming means (20) of the rotor assembly (2) and wherein the second annular part (23) comprises the second set of magnetic pole forming means (21) of the rotor assembly (2) and wherein the first annular part (22) has a different axial length than the second annular part (23).

15. (canceled)

16. A kit of parts for assembling the electrical machine (1) according to claim 0, the kit of parts comprising the following parts: the primary stator assembly (4), the first annular part of the rotor assembly (2), the second annular part of the rotor assembly (2) and the secondary stator assembly (7).

17. (canceled)
